(19) United States
(12) Patent Application Publication
(10) Pub. No.: US 2015/0003812 A1
(43) Pub. Date: Jan. 1, 2015

(54) METHOD FOR COLLABORATIVE CREATION OF SHAREABLE SECONDARY DIGITAL MEDIA PROGRAMS

(71) Applicant: LITTLE ENGINES GROUP, INC., TOPANGA, CA (US)

(72) Inventor: HOWARD DAVID SOROKA, TOPANGA, CA (US)

(21) Appl. No.: 14/315,171

(22) Filed: Jun. 25, 2014

Related U.S. Application Data
(60) Provisional application No. 61/840,398, filed on Jun. 27, 2013.

(51) Int. Cl. H04N 21/8547; H04N 5/935; G11B 27/02

(52) U.S. Cl. CPC H04N 21/8547; G11B 27/02; H04N 5/935
USPC 386/285

(57) ABSTRACT

There is disclosed an apparatus and method for collaborative creation of shareable secondary digital media programs. The method comprises accessing data comprising a primary program generated using an authoring tool and enabling acceptance of a channel of a secondary program, the channel comprising a set of rich metadata time-synchronized with the primary program, from a user of the primary program other than an original creator of the primary program using an authoring tool including timing granularity controls to enable the time-synchronization accuracy to be adjusted between varying levels of fineness. The method further comprises storing the channel time-synchronized with the primary program in a database of rich metadata for access by other users of the primary program, and enabling access, upon request, to the channel time-synchronized with the primary program via a playback tool with varying levels of fineness for the time-synchronization.

### RELATED APPLICATION INFORMATION

This patent claims priority from provisional patent application 61/840,398 filed Jun. 27, 2014 titled “METHOD FOR COLLABORATIVE CREATION OF SHAREABLE SECONDARY DIGITAL MEDIA PROGRAMS”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Purpose of Invention

The purpose of this invention is to provide a tool, typically embodied as computer software, which allows one or more users to create secondary media programs, which are associated with primary media programs such as audio and video files. The secondary programs are themselves a novel concept, introduced herein, as they are not additional linear audio or video programs (typically), but rather are representations of information which can be rendered or “performed” on one or more output devices (such as a video display) differently, depending on numerous configurable parameters which are under consumer control.

Each secondary program serves the purpose of enhancing the experience of using the primary program, by providing tightly synchronized, relevant ancillary information in a variety of formats and/or embodiments. Users of such secondary programs are given a high degree of control over the deployment of the ancillary information, allowing selection of any combination of information types (referred to as “channels”), and configurability of the nature of deployment, such as assignment of specific channels of information to specific display devices

Additionally, the invention provides methods for the collaborative creation of such secondary programs by a diverse and potentially widespread population, and for the sharing of such secondary programs amongst an even larger population, via one or more computer networks.

The secondary programs created by the invention can be used for a wide range of purposes, and when deployed in synchrony with the primary media (digital audio or video) from which they are derived, often create an interactive experience where one did not exist previously. A key characteristic of the Secondary Programs is that they do not need to be integrated into the primary programs (though they can be, if desired). Rather, the primary and secondary programs can be deployed simultaneously but discretely, providing the maximum richness of experience, using the invention itself.

For clarity, an example of a primary program might be an audio file containing a popular song, purchased as a downloadable file from an online music retailer. A corresponding secondary program might be embodied in a second, separate file, containing all of the data necessary to provide an animated visual display of the song's lyrics in several languages, musical notation representing some of the instrumental performances contained in the recording, and images chosen to accompany the music—all of which are synchronized accurately to the timing of the song itself. Such a secondary program might easily be the collaborative work of several creators, each of whom creates only one type or “channel” of the collected ancillary information.

The invention described herein is the tool that is used to create such a secondary program.

### Description of Problem(s) Solved by Invention

There are no known implementations of a technology architecture that addresses a consumer's desire for additional utility from linear media. This is due to several factors. One is certainly the lack of tools to create secondary programs, but another is the assumption that such secondary programs, if they were to exist, would need to be created by the same people creating the primary programs. This invention solves those problems by providing the tool necessary for creation and synchronization, making it available to anyone, and decoupling the resulting secondary program so that the primary media, which is easily available to anyone (once sold on an open market), need never be modified.

### Methods of the Invention

### Background

“Data” is a term meaning “information” (the plural form of the word “datum”, which means a single unit of information). “Metadata” is a term that essentially means “information about information”—that is, information which is descriptive of other information. In the business of digital media, metadata has particular value. For example, when a customer purchases a downloadable song file from an online music retailer, the metadata typically embedded in the song file include such detail as the names of the song, artist and album, the track number, and sometimes more. This metadata is simple and obvious, and of no special commercial value in and of itself.

The term “rich metadata” is often used to describe metadata which does have significant value. Examples of rich metadata in the case of a song might include the text of the song's lyrics, high-quality images, musical notation such as sheet music in digital form, tablature (a form of simplified music notation for stringed instruments), commentary, musicological analysis, links (URLs) to relevant resources stored on the Internet, and much more.

Many types of rich metadata can be organized into, and presented to a user, as discrete (frequently visual) “events”, such as the visual illumination of a single word of a song, at the precise time that it is sung in a recording. In such a case, each “word event” would start at the beginning of the sound of the word being sung, and stop at its audible ending.

A complete and well-synchronized set of such metadata events, therefore, comprises a secondary program, intended to simultaneously accompany the primary audio or video program, composed of modular channels of information, the rendering of which (e.g. the synchronized highlighting of words on a video screen, as they are sung) can be discretely controlled in numerous ways.

The most important methods of the invention therefore, are its facilities for the creation and editing of this metadata, the synchronization of such metadata against a primary program in order to create a self-contained secondary program, and the ability to play back both primary and secondary programs in synchrony, without merging their respective data, in order to provide a comprehensive experience without need for further software.

NOTE: For clarity, as used herein, the terms “playback”, “deployment”, and “rendering” (and sometimes “performance”) are essentially identical, in reference to secondary programs. Similarly, “secondary programs” and “metadata” or “rich metadata” are usually interchangeable.

### How the Invention is an Improvement Over Existing Technology

The invention facilitates a dramatic improvement in the value and utility of commonly used digital media such as digital audio and video, by making such media easily extensible by laypersons to incorporate relevant additional information in a highly usable fashion in the form of one or more secondary programs.

A clear and simple example would be that of a song file. By itself, such a file can provide nothing but a linear listening experience to the consumer. With the addition of a secondary program, it might also teach the consumer how to play the song on an instrument or how to sing it, show information about the composer or performers, and show synchronized images or text, for educational or entertainment purposes. In a less common example, the secondary program can contain synchronized control commands for external devices. In such case, it might be used to control a laser light show, or even an automated fireworks display.

A fundamental concept of the invention however, is that all of this metadata, used to implement the secondary program, is created in a collaborative, channelized fashion, designed for sharing, and need never be combined with the primary media program.

### Design Goals

The typical embodiment of this invention is a computer program that meets the functional descriptions which follow, though it can also be embodied in specific hardware devices, especially when specific subsets of functionality are desired.

The aggregated methods of the invention include, but are not limited to:

Method(s) for creation (“authoring”) of arbitrary rich metadata (such as lyric or text display, musical notation(s), image display, electronic commands to peripheral devices, etc.), coupled with high-resolution time-synchronization data for deployment of such metadata as discrete events, tightly coordinated with audio or video.

Methods for rendering (“deployment”) of created metadata, embodied in playback software and/or hardware devices. Such deployment components may be completely integrated within, or separated from the authoring methods and tools used to create the metadata.

Methods for optional collaboration among a diverse group of authors of metadata, to facilitate sharing of effort, and to enhance the value and applicability of metadata created by the method(s). Collaborators may be geographically separated, with all communication and data exchange facilitated via one or more computer networks.

Representation of all such created metadata in uniform, extensible data structures which are widely applicable, intended for efficient exchange of metadata amongst both collaborators and (non-authoring) end-users. Such exchange may or may not be for commercial purposes. Such metadata may or may not incorporate data encryption, in order to prevent its unauthorized use for either commercial purposes, or personal privacy of its users.

Methods of transferring, storing, deleting, distributing, accessing, and querying such metadata via one or more centralized computer database systems, for commercial and/or non-commercial purposes. Sharing of metadata amongst authors and end-users can be facilitated via such databases, or by direct or indirect transfer between participants.

### Other Novel Aspects of this Invention Include

Organization of metadata as multiple independent channels: Metadata is organized by types, by authors, or by other characteristics, each representing a channel of information, analogous to a multichannel audio recording, and potentially applicable thereto.

De-coupling of metadata from associated reference media: Embedding of metadata into digital media files is entirely optional. This is of paramount importance, as the primary motivation for the invention is the desire to empower anyone—not just the copyright owners of the original media—to significantly enhance the consumer's experience, by adding valuable and pertinent information.

Advanced Synchronization techniques: complete methods for accurate entry and editing of timing information for metadata events, in real and non-real time.

Temporal validation and correction of reference media: Automated detection of minor differences between slightly differing versions of otherwise identical primary programs, and temporal correction (re-synchronization) of associated metadata. Optional implementation of copyright protection per discrete unit of metadata: facility to integrate DRM (Digital Rights Management) software protection to any combination of metadata channels.

Flexible design capability for deployment/display options: facility to design the graphical appearance, screen and screen position assignments, and aesthetic details of rendering of metadata events, and to save

Arbitrary mixing of diverse metadata types in a single display paradigm: there are no arbitrary limits as to types of metadata to be mixed in a given set.

Context-Sensitive Predictive Automatic Event Generation: Automatic generation of certain metadata events, based on metadata context and user controls, to reduce operational complexity

### People Who would Use the Invention

The invention is aimed at the general population. In a typical software embodiment, there are essentially only two categories of users: those who author secondary programs and use them, and those who only use them.

The invention is usable by laypersons or professionals, and is intended to harness the creativity of any population. Those who author secondary programs may be media professionals, teachers, students, or simply amateur enthusiasts. Those who only consume such secondary programs may be anyone at all. Because of the educational aspects of the invention, it is expected that a significant portion of the audience for it will be people with a strong desire to learn, such as students of music.

### Benefits to Users of the Invention

Users of the invention for authoring purposes (creation of secondary programs) have an entirely new method for teaching, entertaining, or otherwise communicating relevant information to an engaged audience. In some cases, this can be monetized such that authors are compensated for their efforts.

Users of the invention for consumption only (no authoring) have a new paradigm for learning information, or simply enhancing the enjoyment of previously-linear (meaning non-interactive) digital media. They can, in many cases, add new secondary programs to digital media files that they have already owned for many years, prior to the availability of the invention

### Brief Description of Invention

The invention is an embodiment in software of a unified methodology for the collaborative, independent creation of secondary programs comprised of synchronized (and non-synchronized) metadata for arbitrary digital media files, for the purpose of experiential enhancement of such digital media, and for the distribution and deployment of such secondary programs to a broad population.

### DESCRIPTION OF THE DRAWINGS

The Applicant has attached the following figures of the invention at the end of this provisional patent application:

FIG. 1: Overview of the Methods Embodied in the Invention

FIG. 2: Collaborative Authoring Process Example

FIG. 3: Example of Authoring Tool User Interface

FIG. 4: Example of Authoring Tool User Interface After Input of Lines of Lyrics

FIG. 5: Example of Authoring Tool User Interface With Granularity of Words

FIG. 6: Example of Authoring Tool User Interface After Synchronization of Words

FIG. 7: Example of Deployment—Simulator Screen Showing Secondary Program With Two Channels of Metadata

FIG. 8: Alternative Embodiment—Implementation of Playback-Only Tool, To Be Used By Consumers Who Do Not Author Content

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### IDENTIFICATION OF PARTS/COMPONENTS FOR INVENTION

| Reference | |
|---|---|
| Numeral | Name of Component |
| 100 | Authoring/Playback Tool (APT—principal embodiment |
| | of invention) |
| 102 | Event entry and validation function |
| 104 | Reference media entry and temporal validation |
| 106 | Operational modes |
| 108 | Real-Time Synchronizer function |
| 110 | Speed control sub-function |
| 112 | Granularity control sub-function |
| 114 | Loop control sub-function |
| 116 | Context-Sensitive Predictive Automatic Event |
| | Generation Function |
| 118 | Channelization function |
| 120 | Rights Management functions |
| 122 | Static Metadata Editing functions |
| 124 | Database Communications function |
| 126 | Data Import/Export (including Multiplexer) functions |
| 128 | Simulation and Deployment engine |
| 130 | Configuration of deployment and display parameters |
| 132 | Real-time rendering engine |
| 134 | Exported Performance (linear media) |
| 136 | Rendered Performance (real-time) |
| 138 | Multichannel Rich Metadata (Secondary program) |
| 200 | APT (identical to 100) |
| 202 | Event entry and validation function (identical to 102) |
| 204 | Synchronization (identical to 108) |
| 206 | Textual Metadata editing (identical to 122) |
| 208 | Data Import (identical to 126) |
| 210 | Simulation and Deployment (identical to 128) |
| 212 | Rich Metadata (secondary sub-programs, as in 138) |
| 214 | Database of Rich Metadata (combined into larger secondary |
| | programs) |
| 300 | Fonts control (part of 130) |
| 302 | Mode controls (part of 106) |
| 304 | Speed control (part of 110) |
| 306 | Granularity control (part of 112) |
| 308 | Loop control (part of 114) |
| 310 | Operational controls (part of 106) |
| 312 | Data Area (for display of events) |
| 700 | Upper screen portion showing synchronized lyrics |
| 702 | Lower screen portion showing synchronized chord diagrams |
| 800 | Playback-Only Tool (Alternate Embodiment) |
| 802 | Multichannel metadata (Secondary Program, identical to 138) |
| 804 | Import of Secondary Program |
| 806 | Reference media entry and temporal validation (identical to 104) |
| 808 | Configuration of deployment and display parameters |
| | (identical to 130) |
| 810 | Real-time rendering engine (identical to 132) |
| 812 | Rendered Performance (real-time) (identical to 136) |

### DETAILED DESCRIPTION

### Description of Apparatus

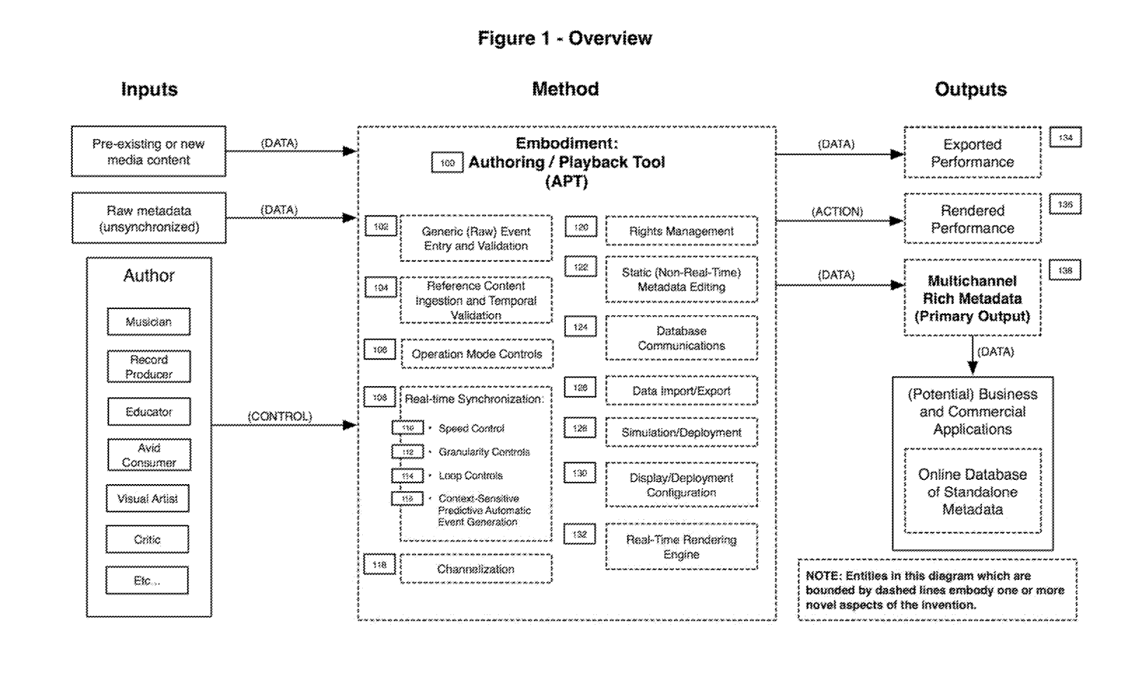

FIG. 1:

The Authoring/Playback Tool (APT) 100 is the primary embodiment of the invention, and is comprised of a number of other functional components. The APT can be embodied entirely in hardware (with firmware), but is more likely to be implemented using purpose-built software on a general computing device such as a desktop computer or touch-operated tablet. (NOTE: the Playback-Only Tool 800, the embodiment of a subset of the APT's capabilities, will be referred to as a PBOT, and discussed later.)

The Functional Components of the APT are:

Generic Event Entry and Validation 102: this component can read and interpret data from the outside world and prepare it for use in the real-time event synchronizer 108. The data can take numerous forms (text, images, device control commands, etc.), including partially completed metadata sets from earlier APT sessions, or other sources. Typically, after ingestion, the raw data represents a list of “events”, to be synchronized against the primary program by the user. Note that while song lyrics are probably the most frequently desired textual metadata for synchronization, there is no limit to textual uses. Other uses might include comments, performer credits, and critical reviews. Further, the raw data need not be text. It can be images, sounds, and even video segments, as practically possible. Essentially, metadata can be derived from almost anything that can have a digital representation.

Reference Content Ingestion with Temporal Validation 104: this component imports existing primary programs such as digital audio or video files. These “reference content” files are used as the time-base against which events are synchronized. Seemingly identical copies of such reference content files can (non-obviously) be slightly different from each other, if obtained from different sources. Typically, small differences might occur in the amount of silence present at the beginning or end of each recording. This is often due to differences in audio compression parameters (MP3, AAC, etc.) as employed by content distributors. When an APT user imports existing synchronized metadata, this component can ensure that the current reference media file matches that which was used to make the imported metadata (Temporal Validation). It can also correct for small differences, or notify the user of significant differences.

Operation Mode Controls 106: These controls govern the main operations of the APT, including some resolution (granularity) functions, and general operational modes such as Editing versus Simulation or Playback.

The Real-Time Event Synchronizer 108: This component plays back the reference content (audio and/or video) in real time, optionally with altered speed (faster or slower than real time), and accepts user synchronization commands via an input device (pushbutton, mouse click, keystroke, etc.). Each synchronization command is associated with a single metadata “event”, as read and prepared by the Raw Data Entry module 102. Events are usually processed in order from first to last, and each is assigned an event time of precisely the point (using the reference content as the time line) at which the user entered the command.

Speed Controls 110: these control the speed at which the reference content is played back, in order to assist the user in entering synchronization commands more accurately. The pitch of audio signals may or may not be affected by the change of speed. Regardless of the speed of playback during synchronization, the recorded time of every event is always based on real-time playback at 100% normal speed.

Granularity Controls 112: These control the “fineness” of resolution of several parameters. One granularity control is for the timing resolution of editing functions with the Static Metadata Editor 122, such that each operation might adjust a specific event time by a factor of 1, 10, 100, or 1000 milliseconds. Another granularity control changes the mode of the APT 100 between “lines” and “words”, for textual metadata such as song lyrics. In “words” mode, each word of the lyrics constitutes a discrete event. In “lines” mode, each whole line constitutes a single event. It is important to understand that the APT allows changing between resolutions without penalty; specifically, the fine granularity of some events is not lost, when the authoring or playback mode is switched to a lower resolution (larger granularity).

Playback Loop Controls 114: The controls allow the designation of “loops”, which are single segments of the reference media, usually less than the full duration, which can be repeated ad infinitum until stopped by the user, at any speed. This allows a user to repeatedly “rehearse” the timing of a given synchronization command, presumably because it is unusually difficult to perform in real time. The user can re-enter the command each time the loop plays (each new command replaces the previous one for any single event), and stop the loop when she is satisfied with the accuracy of the event's timing.

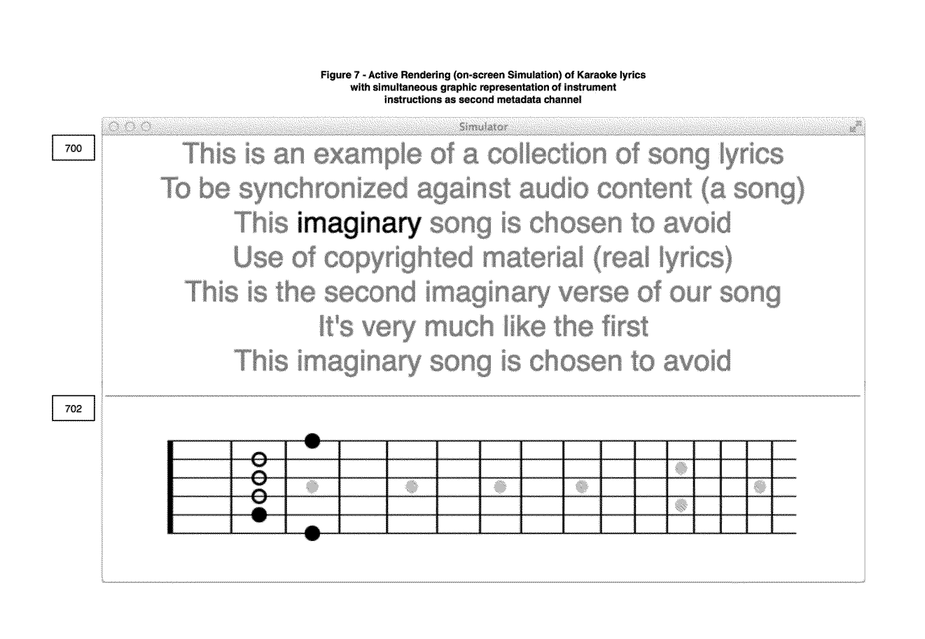

Context-Sensitive Predictive Automatic Event Generator 116: This component can, when the user desires, automatically generate timing data for specific types of events, depending on the nature of those events. This both adds functionality, and reduces the amount of data to be synchronized by the user, where appropriate. One example of generated events would be the “Auto-Stop Times” feature, which automatically generates event stop times as a fixed negative offset from the start time of the next event. This is useful in word synchronization, where frequently words “run together”, that is, there is essentially no silence between words. This allows the user to enter only start times for most word events, allowing the APT to compute their stop times. Another example (shown in FIG. 7) is the automatic generation of a visual preview of a guitar chord shape. In this case, the APT user specifies a sequence of synchronized guitar chord symbols, which appear as black circles on the guitar neck image onscreen. The APT automatically generates symbols for the “next chord” to be played, which are shown as hollow circles. This serves as a visual preview to the guitarist, allowing him to be mentally and physically prepared for the next chord, while still playing the first one.

Channelization 118: These controls facilitate definition of multiple discrete or related metadata sets, and their assignments to specific channels of reference media content. Just as audio can be recorded and played back in a multichannel (greater than two) environment, the APT is intended to create multiple channels of metadata. Each channel can correspond to a single media channel (i.e. audio track), but this is not a requirement. There can be multiple channels of metadata for a single media channel, and vice versa. FIG. 7 shows two channels of metadata being deployed: lyrics for Karaoke (with the current word highlighted), and guitar chords, both synchronized to audio.

Rights management 120: This function allows an author to express details of rights ownership and copyright details for some types of metadata, which might be governed by copyright. This component might also apply DRM (Digital Rights Management) protections to specific portions of the generated metadata (such as some song lyrics), possibly including encryption, in order to prevent unauthorized use or distribution.

Static (non-real-time) Event Editor 122: This component allows the editing of event timings to very fine precision, when needed by the user because real-time event entry is not accurate enough for a given purpose. Typically this is done with buttons or keystrokes, per event, with the resolution of changes to timing data governed by the Granularity Controls 112. In some cases, this also facilitates the entry of specific events which cannot be entered in real time for other reasons.

Database communications 124: This component controls communications between the APT and external entities, such as Internet file servers and remote databases, in order to transmit and/or receive metadata, in large or small quantities.

Data Importer/Exporter/Multiplexer 126: This component exports finished secondary programs in a variety of formats, most often in the form of computer files consisting only of metadata. Such files are a primary output product of the invention, and can be used for numerous purposes, including storage on one or more Internet file servers, making them globally available for diverse purposes. The Data Exporter can also store new metadata in existing files which already contain other metadata, essentially “multiplexing” the new data with the old, in an additive fashion. This component can also import existing secondary programs in a variety of formats, for further authoring or rendering efforts.

Simulation/Deployment 128: This component “performs” the completed media work, including playback of the reference content and all of the associated synchronized events, using the full capabilities of the hardware platform upon which it is implemented. Generally, simulation and deployment are the same thing. They are different only in that deployment is the final version of the completed work, fully realized in its target environment, such as an outdoor venue with multiple large display screens. Simulation is the performance of the same finished work, but it might be constrained in some way, such as with fewer or smaller screens (for example). Nonetheless, the APT itself is an environment used for both simulation and final deployment. Depending upon implementation, this component might also serve as the Real-Time Rendering Engine 132.

Display/Deployment configuration 130: The APT is both an authoring and a final deployment environment. When used for deployment, this component is used to configure both aesthetic and functional characteristics of the “secondary program”, i.e., the rendering of synchronized events when the reference content is played back. Typically, this might involve selection of a number of display screens (such as flat-panel displays), assignment of specific event types to one or more of these screens, or to selected portions of one or more of the screens. It might also involve selection of fonts, colors, visual effects, and other display parameters.

Real-Time Rendering Engine 132: This component is the encapsulated core function of the APT which plays back reference content and associated synchronized metadata. It is intended for environments where sophisticated media playback is needed, but metadata authoring capability is either unnecessary or inappropriate. It can effectively be decoupled from the APT and used as the core of the PBOT, either as a standalone software or hardware product, or integrated (via software or firmware) into third-party products such as software media players, streaming audio client applications, or appliances such as “smart” televisions.

Exported Performance 134: This is a variation of the concept of the rendered performance 136. The exported performance is a recording (or re-recording) of the rendered performance into a specific media type, such as a digital video file. The APT can export performances of many, but not all types of metadata. For example, the APT can render the performance of a song, with sophisticated multi-voice Karaoke lyrics display, along with the original audio, to a single digital video file which can be played back in numerous environments without the need for an APT or a PBOT.

Rendered Performance 136: This is the real-time, ephemeral output of the invention—the “performance” of the secondary program, in synchrony with the primary program. This may take place on one or more peripheral devices (such as video screens), or something entirely different, as in the case of a music-synchronized lighting display, or even a timed pyrotechnics show. All instantiations of this output will require the presence of at least one APT or PBOT implementation. For clarity, this output is ephemeral—it exists only in real time.

Multichannel Metadata (Data Structures) 138: These are the representations of synchronized metadata generated by the APT, as computer files—a resultant output asset of authoring. They are used to drive simulations and deployments, and to populate online databases in the form of computer files. They can be transmitted across networks, ingested and re-used, including potential modification, for numerous purposes, and by diverse users. This is, in other words, the secondary program, represented as a data file.

Additional Information (FIG. 1):

Online Metadata Database: This is a coherent collection of rich metadata sets (secondary programs), from any number of origins, stored on one or more file servers or computers on one or more computer networks, in a well-managed manner. Primarily this facilitates a “clearing house” function to ensure compatibility and enable broad use, and may be used for commercial transactions involving the metadata. There can be more than one database. This is not a component of the invention, but is identified herein to illustrate (as in FIG. 1) that the secondary programs created by the invention can be centrally managed and housed, and distributed widely for both commercial and non-commercial purposes.

Consumers: Consumers are any people who make use of the synchronized metadata, whereas authors are those who create it. There may be people who only do one or the other, but there will be many who do both. In fact, the invention is designed to empower those people the most—ones who can benefit from using secondary programs generated from metadata, and who are also willing and able to author it, and contribute their efforts to an increasing global pool of useful knowledge.

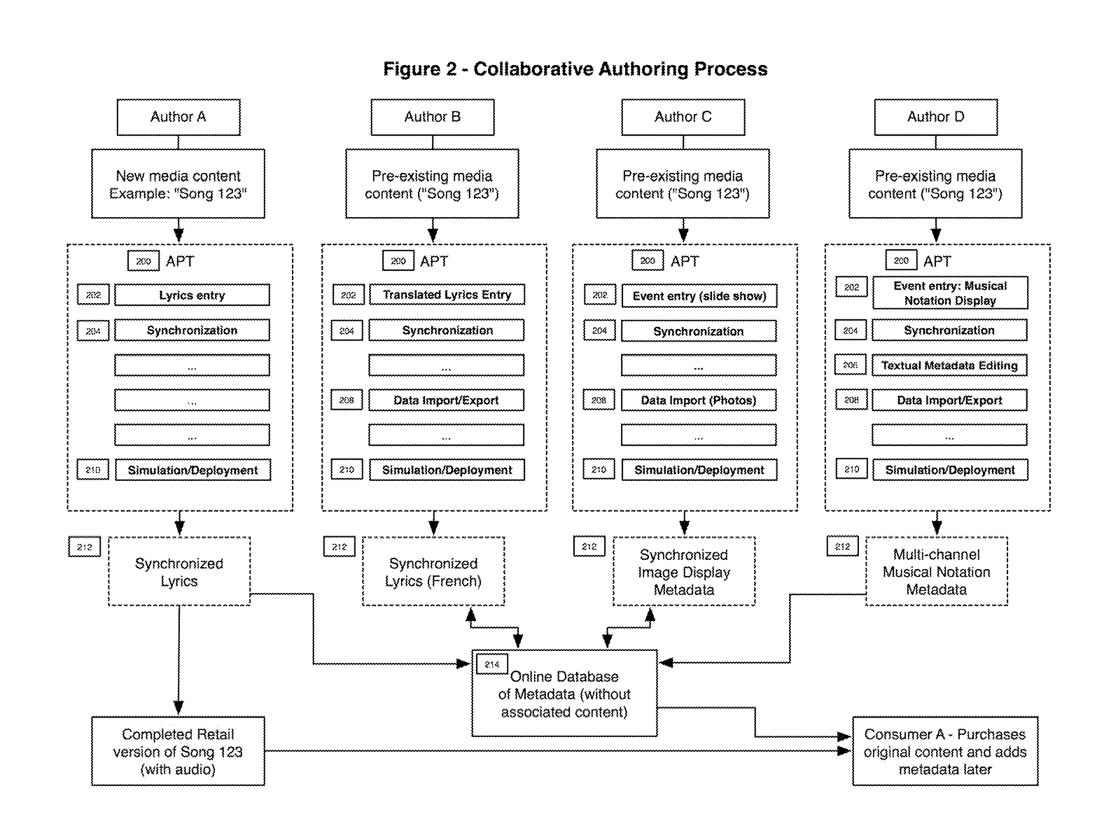

FIG. 2:

FIG. 2 serves to illustrate the usage example given in the next section of this application. All components numerals in FIG. 2 correspond to equivalents in FIG. 1. Please refer to the above chart for identification if necessary.

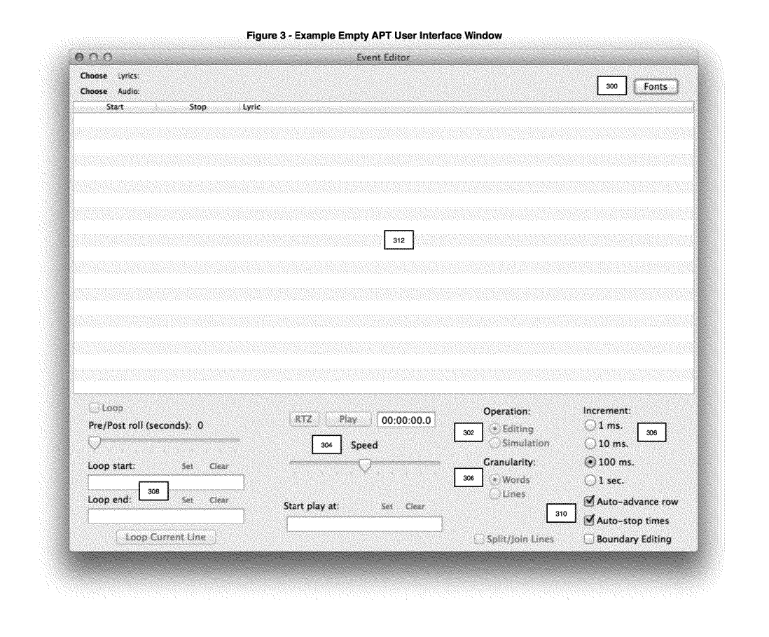

FIG. 3:

FIG. 3 shows a sample screen for one possible embodiment of the invention, as a full-featured APT 100. The Data Area 312 is used to display metadata events which ultimately, after synchronization, comprise a Secondary program. All other numerals in FIG. 3 correspond to equivalents in FIG. 1. Please refer to the above chart for identification if necessary.

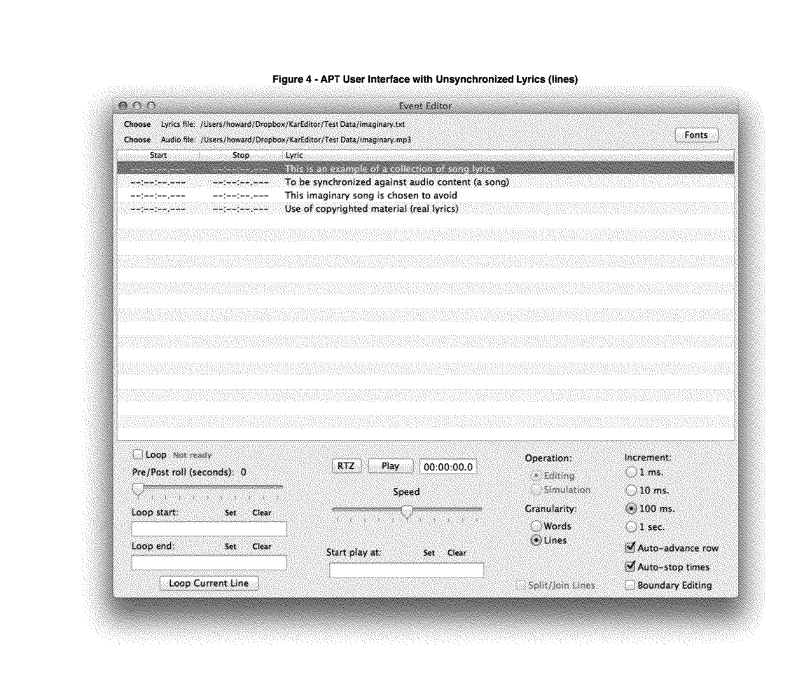

FIG. 4:

FIG. 4 shows a sample APT 100 screen following the importation of a set of song lyrics as lines of text, with a granularity of whole lines, prior to synchronization. It is for illustrative purposes only; there are no numerals.

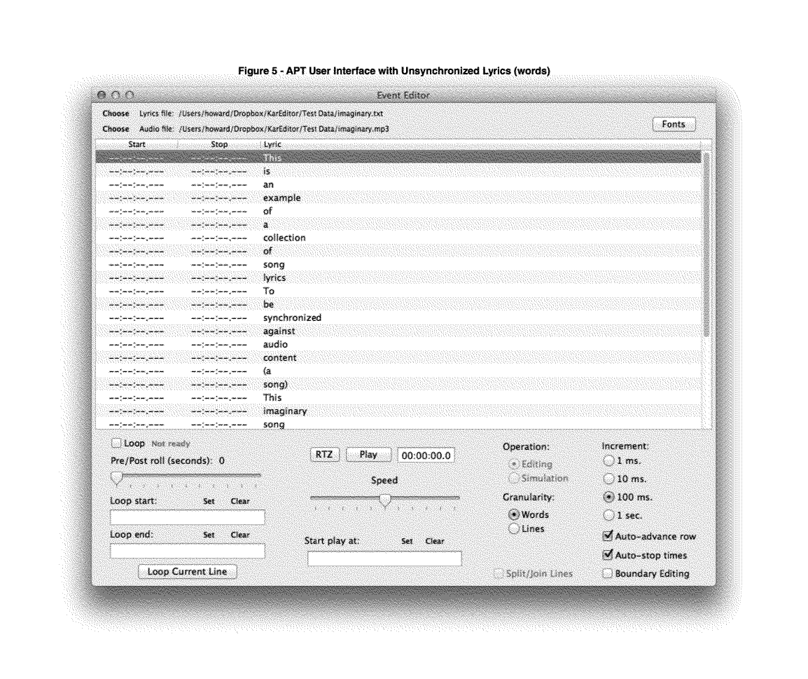

FIG. 5:

FIG. 5 shows a sample APT 100 screen from the same operational session as FIG. 4, but after changing the granularity to words (from whole lines), prior to synchronization. It is for illustrative purposes only; there are no numerals.

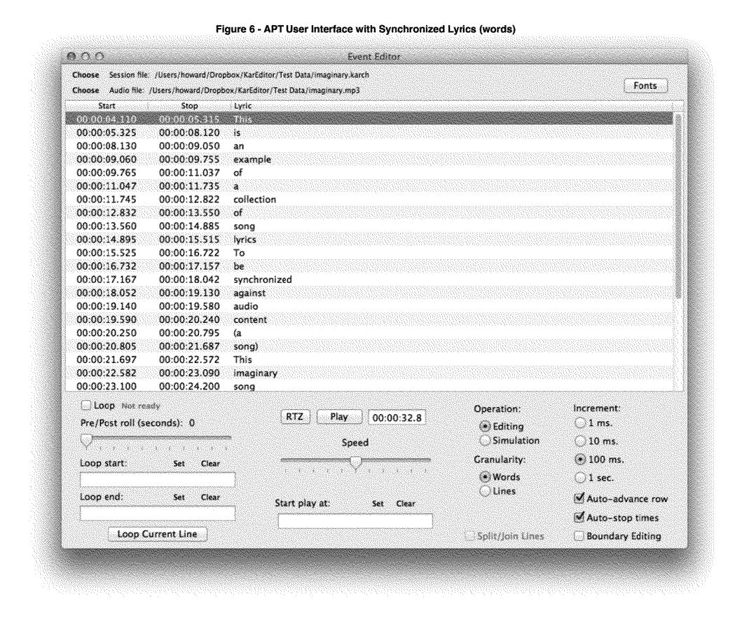

FIG. 6:

FIG. 6 shows a sample APT 100 screen from the same operational session as FIGS. 4 and 5, with a granularity of words, after synchronization. It is for illustrative purposes only, there are no numerals.

FIG. 7:

FIG. 7 shows a sample screen from a real-time rendering (performance) 136 of a secondary program. In this example, the upper portion of the rendered display 700 shows a set of lyrics. The word “imaginary” is highlighted as if it is the word currently being sung at the instant this sample screen is captured. The lower portion of the screen 702 shows a graphic of a guitar neck. The solid black circles represent the chord that should be played at the current instant in time. The hollow black circles show the next chord to be played. This next chord symbol has been automatically generated by the Context-Sensitive Predictive Automatic Event Generation Function 166 of the APT 100.

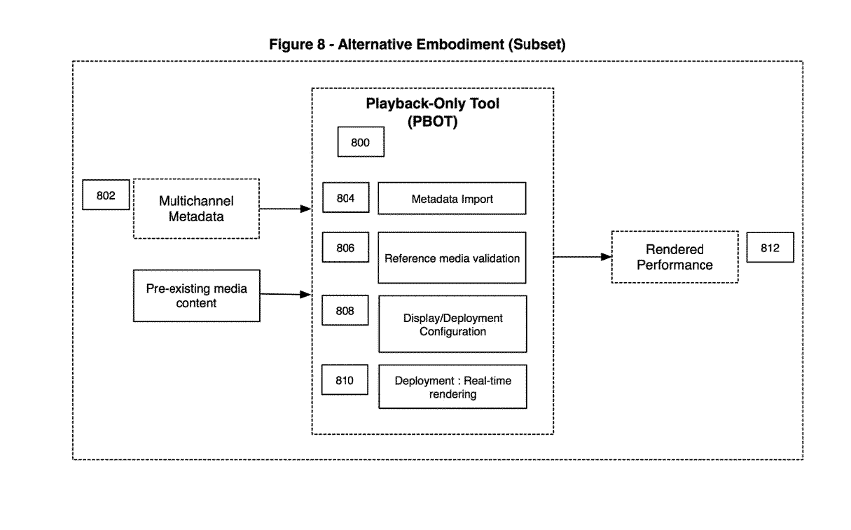

FIG. 8:

The Playback-Only Tool (PBOT) 800 is the principal common alternative embodiment of the invention (discussed further in a subsequent section). This is an alternative embodiment in that it is a subset, albeit a highly useful one, of the scope of capabilities of the full invention.

The Secondary Program Import function 804 is the portion of the PBOT that imports entire, complete Secondary Programs for playback. All other components of the PBOT have corresponding equivalents in FIG. 1. Please refer to the above chart for identification if necessary.

Operation and Relationship Between the Parts of the Invention:

The invention, as embodied in software, is explained at a high level by FIG. 1. The principal embodiment is the APT 100, which has diverse Authors who operate it. They provide inputs to the APT in the form of raw, unsynchronized metadata, and reference media content (primary programs). They use the APT to perform editing, synchronization, configuration and the other operations of the APT as described earlier. The output of the process is synchronized rich metadata, which we also refer to as secondary programs. Each author can create a different secondary program for a given piece of reference media consisting of any number of channels of metadata. Each of these can be treated discretely, or combined into a collection of all of the channels, from all of the authors, or any subset thereof. In all cases, regardless of the number of channels, the output of the APT is a secondary digital media program, which can take any of the three forms: (ephemeral) rendered performance, (stored) exported performance (such as a digital video file), or a stored computer file containing a secondary program comprised of rich multichannel metadata.

In FIG. 2, the operation of the invention is described through an example scenario, for a typical, common application: the collaborative creation of a standalone metadata set for a specific popular song, and its subsequent uses.

Detailed Explanation of FIG. 2:

(To reduce complexity in the drawings, components referred to in the following discussion may be identified by the numerals from any of the Figures.)

Authors:

Author A: A professional record producer whose first language is English. This Author will create synchronized lyrics metadata to facilitate the use of the song for “Karaoke”—the extremely popular pastime in which amateur singers perform for an audience, replacing the lead vocal performances for popular songs. (As an aid to the Karaoke performer, song lyrics are displayed on a screen, and each lyric is visually highlighted at precisely the moment at which it is sung in the recording.)

Author B: An avid music fan whose first language is French.

Author C: An avid amateur photographer who is both a fan of the recording artist, and a friend of the record producer.

Author D: A professional guitar instructor who frequently publishes educational materials using the Internet.

Operations:

Author A produces a record by a popular artist. Before the recording is released for sale, Author A uses the APT 200 to create a metadata set for the song, to enable “Karaoke” usage. He first enters the lyrics of the song as plain text 202, by importing a text file that contains them. He then synchronizes the lyrics of the song to the music 204, on a word-by-word basis. He enters a start time for each word event, but only adds end times for a few words, as the end times of most words are added automatically 116 (typically a few milliseconds before the start time of the next word). He edits the synchronization data for accuracy 122. He chooses a default setting for font, text size, colors, and screen layout to present an aesthetically pleasing display of lyrics during playback 130. Finally, he enters descriptive, non-synchronized textual metadata describing the song (Artist name, track name, album name, recording details, etc.) 122. He uses the APT in Simulation mode 210 to verify in real time that the event timings and other information are accurate. When all is complete, he exports all metadata to a file 212. This file is a secondary program, containing 1 channel of synchronized metadata, and 2 channels of unsynchronized metadata. He sends both the file and the master multitrack audio file to the record company (distributor) for whom he is producing the song. The record company processes the files for distribution and sale to the public, which can optionally include combining them into a single file.

Author B purchases a copy of the song from an online music retail website. He translates the lyrics into French. He uses the APT 200, using all the same processes that the record producer used, to add the French lyrics to the song's metadata 202. He synchronizes the French lyrics with the English recorded performance, as closely as he can 204. He stores his French lyrics within his own copy of the song on his own computer, using the APT's data exporting/multiplexing functions 208. He then exports a metadata file 212 containing the synchronized French lyrics, but specifically, no audio data. This file is a secondary program, containing 1 channel of synchronized metadata. He uploads this file to an online database 214 of user-created metadata, to make it available to other French-speaking music fans.

Author C is notified of the impending release of the song by her friend, Author A. Author A suggests to Author C that the song might be enhanced with a selection of photos of the recording artist, many of which have been taken by Author C. Author C then purchases a copy of the song from an online music retail website. Using the APT 200, Author C adds a selection of photos to the song's metadata 202, and synchronizes each photo for display at a particular point during the song 204. Author C adds the photos in two ways: she adds literal copies of the photos in a small size to the metadata file itself. Additionally, for each photo, she adds a URL (website address, or link) which points to a very high-resolution, high-quality version of the photo, stored on a photo file server on the Internet. This file is a secondary program, containing 1 channel of synchronized metadata. She then uploads the file (including the small photos, and links to the large ones) 212 to the same online database 214 used by Author B, to make the synchronized photos available to other fans of the artist. (The photos and URLs are all part of the single channel of metadata in the file.)

Author D purchases a copy of the song from an online music retail website. He listens to it carefully, and determines precisely which chords are being played by the guitarist on the recording. He then uses the APT 200 to enter (common, well-understood) graphic diagrams of each chord's fingering 202, and then precisely synchronizes 204 each of the chord symbols with each point in the song at which it is played. The APT automatically generates “preview” symbols for each guitar chord 116, without author intervention. (Using a graphically distinctive style, the preview chord shows the user which chord will be the next to be played when the current one ends. This allows the user to be well-prepared for chord changes as they occur.) Once this is complete, Author D enters a second channel of metadata 202: tablature (a form of simplified musical notation for stringed instruments) of the bass guitar part of the song. This is a second operation, much like the first, though the visual style of the displayed graphics is different. Finally, much like the other authors, Author D then reviews his work using the APT's simulator 210, and uploads the finished file containing only his original metadata to the same online database 214. This file is a secondary program, containing 2 channels of synchronized metadata.

Resulting Uses:

The activities of the four Authors described above illustrate how the invention is used to collaboratively create, test, and distribute very rich synchronized metadata used to enhance the value of a media product (an audio recording), without actually altering (or re-distributing) the recording itself. Each author has created a single secondary program, consisting of one or more channels, which can be used by itself. By uploading each individual's secondary program to a central database 214 (this is an optional step), the work of the individuals can be combined into a larger secondary program, containing all of the channels, and made accessible to a large population. Such a secondary program, if all channels were deployed at once (an unlikely event), would show English and French Karaoke lyrics, photos, guitar chords and bass guitar tablature, all synchronized to the playback of the song. More likely, the consumer would use the Display/Deployment configuration capability 130 of his APT or PBOT, to select only the desired few channels of metadata for rendering—a much more likely use of the secondary program which accompanies the song.

For a more elaborate example, consider one consumer with many interests (for simplicity of explanation). This person (“Consumer A”) is a fan of the aforementioned recording artist. Additionally, he owns a smart phone and a desktop computer, enjoys photography, has a Francophone girlfriend, and is learning sing and to play the guitar. Both of his devices (phone and computer), are outfitted with software 800 for playback of media files which include rich metadata.

Consumer A purchases a copy of the song, in a multi-channel audio format, from an online music retail website, using his mobile phone. Specifically, it has not just stereo channels (only right and left channels of all instruments and voices, mixed together), but rather has stereo tracks for each major group of instruments, each of which can be separately controlled (these are commonly called “stems”). In this case, there are stems for drums, lead vocals, background vocals, bass guitar, rhythm guitar, piano, and organ. By default, all stems are played at normal volume, such that the song sounds like a traditional stereo recording unless the listener changes the volume of one or more individual stems. The song file also contains all of the rich metadata described above.

After initial purchase, Consumer A queries the online database 214 of customer-supplied metadata to find out if any new metadata is available for the songs. He discovers the free availability of synchronized French lyrics, photos, and instructional musical notation for guitar and bass guitar 212. He downloads all of these and they are automatically associated with the song file he has already purchased (by his PBOT software 800, or web-browser client). Consumer A turns on the visual display feature of his media player 800, and enjoys the synchronized images along with the music.

Later that evening he transfers a copy of it to his computer, to enjoy it with a larger screen and better speakers. He indicates that he would prefer high-resolution photos, so his computer-based player downloads and displays the better quality images, using the URLs that were added to the synchronized metadata by Author C, instead of the smaller images intended for his phone. He then decides to learn how to play and sing the song. He configures his player 800 to display both Karaoke-style lyrics and guitar chords, in two portions of his computer's screen simultaneously. He uses the chord symbols (courtesy of Author D) to learn how to play the song on guitar, and practices singing at the same time. When he feels confident that he knows the words, he lowers the volume of the audio stem containing the lead vocal part, so that he can now sing along with the song, with his own voice replacing that of the original performer. Later, when his girlfriend comes to visit, he shows her how he learned to play and sing the song. She remarks that she likes it, but doesn't understand all of the English words. He then enables 130 the display of the French translation of the lyrics, and plays the song again for her, so she can read the translation and understand the meaning. Finally, upon seeing the synchronized display of bass guitar tablature that is also available from the song file, Consumer A's girlfriend decides to take up playing the instrument.

### Alternative Embodiments

The Playback-Only Tool (PBOT) 800 is the principal common alternative embodiment of the invention, in that it is a subset of the aggregate functionality. This is simply an encapsulated subset of the full rendering and display configuration capabilities of the APT, without any facility for authoring. It is useful for users who have no desire to author, and for embedding into other, larger software or hardware products that need only playback capability.

For another example of an alternative embodiment, imagine an avid listener who enjoys music that is mixed specifically for the popular “5.1” Surround Sound format (using six speakers instead of the more common two). Given an audio recording consisting of multiple stems (as described earlier), which by default are only configured to be playable in pure stereo, one embodiment of the invention would allow this user to create his own original surround sound mix of the music, and to share that mix with other like-minded enthusiasts. An excellent embodiment might take the form of a software user interface which graphically represents a 3 dimensional space—a listening room. This could be implemented on a small tablet device, for the ease of manipulating graphical objects, and for the user's comfort—it could be used while sitting in a comfortable chair in the middle of just such a space. The user could assign and position individual audio stems to one or more of the six speakers, using graphical symbols to represent speakers and instruments. These could be changed in real time as the music plays, and all such assignments, positions, and changes could be recorded as real-time metadata. Such metadata could then be shared as discussed earlier. In this way, other surround-sound enthusiasts might also enjoy the work of the original amateur “mixer”. As an option, the final enjoyment of such surround sound mixes could be achieved by rendering the final version, with all real-time movements and changes, to a monolithic file in one of the popular surround formats, such as Dolby AC3, or DTS Surround (an exported performance 134). Or, the consumer's recorded surround sound “mix” of the music could simply be saved and shared as a secondary program—a computer file containing rich multichannel metadata 212.

In this example, the APT is embodied in the tablet device with the graphical user interface for surround sound mixing, and the final (novel) result is the real-time metadata describing that mix. (The actual technology used to encode and render surround sound mixes is long-established, and not in the scope of this invention.)

Finally, an unusual example of a very unique embodiment might take the form of a refreshable Braille display (a device used to present changing textual information to a blind user), with an integrated PBOT 800, used to display synchronized Karaoke lyrics in Braille.

Alternative Uses:

The invention is broadly applicable. Accordingly, there can be many uses for it, many of which may have yet to be imagined. Among those, however, are several categories, the knowledge of which will guide the reader in understanding the primary aims of the invention.

Professional Media Production: Creation of very rich metadata to be supplied to customers purchasing digital audio or video products, as secondary programs.

Arts, Entertainment, Recreation: Creation of secondary programs by end-users, for purposes of entertainment, communication, self-expression.

General Education: Creation of secondary programs that enhance the value of audio and video material as a general education medium.

Music Education: In particular, the invention enables numerous new methods of conveying musical information both for interactive voice and instrument training methods, and for musicological study. Of particular importance is the ability of the APT to serve as both an authoring and rendering environment, with very flexible playback options for reference media, such as speed controls and looping. Using these capabilities, a student musician can specify segments of recordings as events, play them back at any speed in a looped or alternatively sequenced fashion, in order to practice difficult vocal or instrumental parts of a composition along with the recording, with only the desired audio channels audible (in the case of multichannel audio recordings). This makes the APT a unique and versatile practice tool for musicians, which is, in fact, one of the design goals of the invention.

Languages: The ability to incorporate user-supplied language translations of textual material opens new opportunities for language students to experience new and compelling teaching methods.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. Apparatus comprising a storage medium storing a program having instructions which when executed by a processor will cause the processor to:
access data comprising a primary program generated using an authoring tool;
enable acceptance of a channel of a secondary program, each channel comprising a set of rich metadata time-synchronized with the primary program, from a user of the primary program other than an original creator of the primary program using an authoring tool including timing granularity controls to enable the time-synchronization accuracy to be adjusted between varying levels of fineness;
store the channel time-synchronized with the primary program in a database of rich metadata for access by other users of the primary program; and
enable access, upon request, to the channel time-synchronized with the primary program via a playback tool with varying levels of fineness for the time-synchronization.

2. The apparatus of claim 1 wherein multiple versions of the primary program exist, each with timing different from one another, and wherein the instructions, when executed by the processor, will cause the processor to automatically alter a timing associated with the secondary program to correspond to one of the multiple versions currently being accessed via the playback tool.

3. The apparatus of claim 1 wherein the instructions, when executed by the processor, will cause the processor to automatically generate events for use in time synchronization for the primary program.

4. The apparatus of claim 1 wherein the instructions, when executed by the processor, will cause the processor to accept adjustment of the fineness of the time-synchronization for only a portion of the primary program.

5. The apparatus of claim 1 wherein the instructions, when executed by the processor, will cause the processor to enable looping of one portion of the primary program so that the channel may be accepted after more than one revision input while accessing one or more loops of the one portion.

6. The apparatus of claim 5 wherein the instructions, when executed by the process, enable the granularity controls to alter the fineness only over the one portion.

7. The apparatus of claim 6 wherein the one portion includes words in the form of one of spoken dialogue and lyrics and the granularity controls enable the channel to properly match a timing associated with the words.

8. The apparatus of claim 1 wherein the primary program comprises at least one of audio data and video data.

9. The apparatus of claim 1 wherein the granularity controls can vary the fineness between one second accuracy and 1/1000th of a second accuracy.

10. The apparatus of claim 1 further comprising:
a processor
a memory
wherein the processor and the memory comprise circuits and software for performing the instructions on the storage medium.

11. A method comprising:
accessing data comprising a primary program generated using an authoring tool;
enabling acceptance of a channel of a secondary program, each channel comprising a set of rich metadata time-synchronized with the primary program, from a user of the primary program other than an original creator of the primary program using an authoring tool including timing granularity controls to enable the time-synchronization accuracy to be adjusted between varying levels of fineness;
storing the channel time-synchronized with the primary program in a database of rich metadata for access by other users of the primary program; and
enabling access, upon request, to the channel time-synchronized with the primary program via a playback tool with varying levels of fineness for the time-synchronization.

12. The method of claim 11 wherein multiple versions of the primary program exist, each with timing different from one another, and further comprising automatically altering a timing associated with the secondary program to correspond to one of the multiple versions currently being accessed via the playback tool.

13. The method of claim 11 further comprising automatically generating events for use in time synchronization for the primary program.

14. The method of claim 11 wherein further comprising accepting adjustment of the fineness of the time-synchronization for only a portion of the primary program.

15. The method of claim 11 further comprising enabling looping of one portion of the primary program so that the channel may be accepted after more than one revision input while accessing one or more loops of the one portion.

16. The method of claim 15 further comprising enabling the granularity controls to alter the fineness only over the one portion.

17. The method of claim 16 wherein the one portion includes words in the form of one of spoken dialogue and lyrics and the granularity controls enable the channel to properly match a timing associated with the words.

18. The method of claim 11 wherein the primary program comprises at least one of audio data and video data.

19. The apparatus of claim 11 wherein the granularity controls can vary the fineness between one second accuracy and 1/1000th of a second accuracy.
